(19) United States
(12) Patent Application Publication
(10) Pub. No.: US 2024/0254341 A1
(43) Pub. Date: Aug. 1, 2024

(54) FIRE PROTECTION AND INSULATION COMPOSITION AND METHOD OF USE THEREOF

(71) Applicant: MATWERKZ TECHNOLOGIES PTE. LTD., Singapore (SG)

(72) Inventor: Yew Wei LEONG, Singapore (SG)

(73) Assignee: MATWERKZ TECHNOLOGIES PTE. LTD., Singapore (SG)

(21) Appl. No.: 18/565,447

(22) PCT Filed: May 30, 2022
(86) PCT No.: PCT/SG2022/050366

§ 371 Date: Nov. 29, 2023

(30) Foreign Application Priority Data
May 31, 2021 (WO) PCT/SG2021/050304

(51) Int. Cl. C09D 5/18; C09D 7/61; H01M 50/383

(52) U.S. Cl. CPC C09D 5/18; C09D 7/61; H01M 50/383

(57) ABSTRACT

A fire protection and insulation composition comprising: sodium and/or lithium silicate, and additional or other filler or binder material, wherein the composition, when applied to a said battery cell, acts as a thermally conductive coating at normal working temperatures of the battery cell, and wherein the sodium and/or lithium silicate undergoes hydrothermal crystallization into amorphous silica when exposed to higher temperatures such that the coating acts as a thermally insulative barrier for the battery cell.

### FIELD

The present invention relates to a fire protection and insulation composition and method of use thereof. While the invention is described with reference to its use with battery cells, it is to be appreciated that the present invention is not limited to this application, and that other applications are also envisaged.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Battery thermal runaway is the main cause of explosion of electric vehicles and bikes during charging. Thermal runaway occurs when the li-ion cells are overcharged and reaches a threshold temperature, after which the temperature would increase rapidly on its own. Thermal runaway barriers have been used to suppress the propagation of fire during a thermal runaway.

Thermal management materials in battery modules have essentially been classified into two categories, i.e. thermal interface materials and thermal runaway barriers. Thermal interface materials are responsible for dissipating heat away from the battery cells during their normal working temperatures of between 20-80° C. Therefore, these materials are inherently thermally conductive. However, at higher temperatures, e.g., 250° C., these materials tend to melt and/or degrade and will not be able to provide adequate protection against fire propagation in the event of a thermal runaway. Thermal runaway barriers, on the other hand, are inherently thermally insulative and therefore able to prevent fire from spreading from one part of the battery module to the other in the event of a thermal runaway. However, these barriers are unable to dissipate heat under the normal battery working conditions. Therefore, the battery life would tend to be degraded due to its exposure to elevated temperatures for prolonged periods.

It would therefore be advantageous to have a thermal management material that can act as a thermal interface material at normal working temperatures of a battery cell, and as a thermal runaway barrier in the event of a thermal runaway.

### SUMMARY

According to an aspect of the present disclosure, there is provided a fire protection and insulation composition comprising: sodium and/or lithium silicate, and an additional or other filler or binder material, wherein the composition, when applied to a said battery cell, acts as a thermally conductive coating at normal working temperatures of the battery cell, and wherein the sodium and/or lithium silicate undergoes hydrothermal crystallization into amorphous silica when exposed to higher temperatures such that the coating acts as a thermally insulative barrier for the battery cell.

In some embodiments, the filler material comprises one or more of a pore-forming agent, rheology modifier, thermal insulation filler, and thermal conductive filler.

In some embodiments, the pore-forming agent is a starch.

In some embodiments, the pore-forming agent is provided by the sodium and/or lithium silicate.

In some embodiments, the rheology modifier is a starch, fumed silica and/or cellulose or cellulose derivatives.

In some embodiments, the starch is derived from corn, tapioca, wheat or rice.

In some embodiments, the thermal insulation filler is fumed silica and/or aerogel.

In some embodiments, the thermal conductive filler is selected from one or more of the following: boron nitride, aluminium nitride, aluminium oxide and magnesium oxide.

In some embodiments, the fire protection and insulation composition further comprise a UV curing agent.

In some embodiments, the fire protection and insulation composition further comprise cellulose.

In some embodiments, the fire protection and insulation composition further comprise a surfactant.

In some embodiments, the fire protection and insulation composition further comprise gypsum.

In some embodiments, the sodium and/or lithium silicate is in the range of 35-60 Baume.

In some embodiments, the sodium and/or lithium silicate is in the form of a powder.

In some embodiments, the fire protection and insulation composition comprise:
a) 90-95 wt % of sodium silicate;
b) 1-5 wt % of corn starch;
c) 1-5 wt % of cellulose; and
d) 1-5% of a surfactant.

In some embodiments, the fire protection and insulation composition comprise:
a) 30-50 wt % of sodium silicate;
b) 5-20 wt % of lithium silicate;
c) 30-50 wt % of aluminium nitride;
d) 1-5 wt % of corn starch;
e) 1-5 wt % of fumed silica; and
f) 1-5 wt % of a surfactant.

In some embodiments, the fire protection and insulation composition comprise:
a) 50-65 wt % of sodium silicate;
b) 30-50 wt % of boron nitride;
c) 1-5 wt % of irgacure 819;
d) 1-5 wt % of cellulose; and
e) 1-5 wt % of a surfactant.

In some embodiments, the fire protection and insulation composition comprise:
a) 50-60 wt % of sodium silicate;
b) 30-59 wt % of boron nitride;
c) 1-5 wt % of fumed silica;
d) 1-5 wt % of cellulose; and
e) 1-5 wt % of surfactant.

In some embodiments, the fire protection and insulation composition comprise:
a) 40-60 wt % of sodium silicate (SiO2:Na2O=3.22);
b) 30-50 wt % of boron nitride; and
c) 3-15 wt % gypsum.

In some embodiments, the sodium and/or lithium silicate is in the form of a sodium and/or lithium metasilicate hydrate.

In some embodiments, the sodium and/or lithium metasilicate hydrate is in the form of sodium metasilicate pentahydrate, sodium metasilicate nonahydrate, lithium metasilicate, or lithium disilicate.

In some embodiments, the sodium and/or lithium metasilicate hydrate is in an encapsulated form.

In some embodiments, the binder material is silicone rubber RTV.

In some embodiments, the binder material is silane-grafted polyurethane.

In some embodiments, the binder material is water-based acrylic.

In some embodiments, the binder material is siloxane.

In some embodiments, fire protection and insulation composition further comprise a thermal conductive filler.

In some embodiments, the thermal conductive filler is selected from one or more of the following: boron nitride, aluminium nitride, aluminium oxide and magnesium oxide.

In some embodiments, the fire protection and insulation composition comprise:
a) 30-70 wt % of silicone rubber RTV;
b) 20-70% of boron nitride; and
c) 10-30 wt % of acid treated sodium metasilicate pentahydrate.

In some embodiments, the fire protection and insulation composition comprise:
a) 30-70 wt % of silicone rubber RTV;
b) 30-70 wt % boron nitride;
c) 10-30 wt % acid treated lithium metasilicate; and
d) 10-30 wt % encapsulated sodium metasilicate nonahydrate

In some embodiments, the fire protection and insulation composition comprise:
a) 30-70 wt % of silicone rubber RTV;
b) 30-70 wt % aluminium nitride; and
c) 10-30 wt % encapsulated sodium metasilicate pentahydrate.

In some embodiments, the fire protection and insulation composition comprise:
a) 30-70% silane-grafted polyurethane;
b) 20-70% boron nitride;
c) 1-5% siloxane;
d) 1-3% surfactant; and
e) 10-30% sodium metasilicate pentahydrate.

In some embodiments, the fire protection and insulation composition comprise:
a) 30-70% water-based acrylic;
b) 20-70% boron nitride;
c) 1-3% surfactant; and
d) 10-30% sodium metasilicate pentahydrate.

In some embodiments, the fire protection and insulation composition comprise:
a) 30-70% silicone rubber RTV;
b) 10-50% boron nitride;
c) 20-50% siloxane;
d) 1-3% surfactant; and
e) 10-30% sodium metasilicate pentahydrate.

In some embodiments, the fire protection and insulation composition further comprises 5 to 30 wt % of reinforcement material.

In some embodiments, the reinforcement material is selected from one or more of the following: glass/ceramic wool, chopped-strands, fibers or whiskers.

According to another aspect of the present invention, there is provided a composite sheet comprising and inorganic substrate layer, to which is applied a layer of the fire protection and insulation composition.

In some embodiments, the inorganic substrate layer is in the form of a glass/ceramic mat or a fabric.

According to a further aspect of the present disclosure, there is provided a method of providing fire protection and insulation for a battery cell, comprising coating or covering at least a cathode and/or a vent of the battery cell with a fire protection and insulation coating as described above.

Other aspects and features will become apparent to those of ordinary skill in the art upon review of the following description of specific embodiments in conjunction with the accompanying figures.

### BRIEF DESCRIPTION OF THE DRAWINGS

In the figures, which illustrate, by way of example only, embodiments of the present invention.

FIG. 1 is a photographic image showing a left image which shows encapsulated metasilicate particles, and a right image which shows an optical microphotography of sol-gel formed shells after the metasilicate core was extracted with water.

FIG. 1 (a) is a photographic image showing a battery cell coated with the fire-protection and insulative coating according to the present disclosure at the cathode terminal of the battery cell where the battery vent is also situated;

FIG. 1(b) is a photographic image showing the test setup used to heat the coated battery cell to temperatures above 160° C.;

FIG. 1(c) is a photographic image showing the formation of intumescent foam at the coated part of the battery cell after 10 minutes of heating;

FIG. 1(d) is a photographic image showing the appearance of the coated side of the battery cell after 90 minutes of heating above 160° C., where no initiation of thermal runaway was detected;

FIG. 3 is a photographic image showing a fire test being conducted on a steel substrate coated with a fire protection and insulation coating according to the present disclosure;

FIG. 4 is a graph comparing the substate temperatures between coated and uncoated substrates during the test shown in FIG. 3;

FIG. 5(a) is a photographic image showing the appearance of highly thermally conductive PDMS compound before exposure to high temperature;

FIG. 5(b) is a photographic image showing the PDMS compound of FIG. 5(a) foaming upon exposure to high temperatures;

FIG. 5(c) is a photographic image showing how the foaming would also cause expansion to the PDMS compound of FIG. 5(a);

FIG. 6 is an exploded view of a battery module including a top protection sheet having a composition according to the present disclosure; and

FIG. 7 is a photographic image of a battery holder and top protection sheet of the battery module of FIG. 6 following exposure to temperatures above 120° C.

### DETAILED DESCRIPTION

Throughout this document, unless otherwise indicated to the contrary, the terms “comprising”, “consisting of”, “having” and the like, are to be construed as non-exhaustive, or in other words, as meaning “including, but not limited to”.

Furthermore, throughout the specification, unless the context requires otherwise, the word “include” or variations such as “includes” or “including” will be understood to imply the inclusion of a stated integer or group of integers but not the exclusion of any other integer or group of integers.

According to the present disclosure, there is provided is a highly thermally conductive composition that is primarily formulated to be coated or placed on battery cells in order to help dissipate heat during normal battery operating temperatures of between 20-80° C. for example. However, should the battery cells overheat to above 120° C. for example, the composition will transform into a thermally insulative barrier through foaming that is caused by hydrothermal crystallization. This composition may not contain any intumescent flame retardants or blowing agents that releases phosphate-nitrogen compounds. The composition can be produced in different forms including, but not limited to a coating, potting material, paste or as a solid sheet.

According to one aspect of the present disclosure, the fire protection and insulation composition, when used as a coating, may use sodium silicate and/or lithium silicate as its main component, which in itself is non-combustible. Various grades of sodium/lithium silicate with different SiO2:Na2O or SiO2:Li2O content can used, e.g., 35-60 Baume. It is also envisaged that the sodium/lithium silicate be used in the form of a sodium/lithium metasilicate in the fire protection and insulation composition according to the present disclosure, examples of which will be subsequently described.

The viscosity and transparency of the sodium/lithium silicate can be tailored based on its grade and also incorporation of fillers as well as surfactants. The mixture of sodium and lithium silicates can also provide various degrees of water resistance to the coating. The fillers used consist of a mixture of starch, fumed silica, cellulose and ceramics, each of which would contribute differently but synergistically to the thermal conductivity, thermal insulation and fire-resistant performance of the coating. The starch can be derived from corn, tapioca, wheat or rice. Starch is used as a pore-forming agent as well as a rheology modifier for the coating. Cellulose and its derivatives can also be used as a rheology modifier. It will create a porous but more compact structure in the silicate so that it forms an insulation wall upon exposure to naked flame. This is an especially critical when it comes to thermal runaway prevention in batteries, which will be discussed later. The sodium and/or lithium silicate can also act as a pore-forming agent. Furthermore, heat reflectivity by the coating can be achieved via char formation from the starch when it comes in contact with a flame. Fumed silica is used as an effective rheological modifier such that the silicate can be formulated into a paste or gel. In this coating, fumed silica was found to have a synergistic effect with starch to act as a flame retardant additive as well as to stabilize and strengthen the char layer formation such that the coating does not crack after prolonged exposure to flame. Aerogel could also be used as a thermal insulation filler. Unlike conventional intumescent coatings that rely on gases such as nitrogen and phosphate to create foam-like structures with large open cells, the cell structure in the fire protection and insulation coating according to the present disclosure is closed and more compact. These features are critical for the coating to provide good insulation performance and prolong the heating of the substrate when exposed to flame. In certain cases, UV curing agent such as Irgacure 819 (registered trademark of BASF) is incorporated in order to attain fast setting of the coating and prevent dripping, especially when the coating is sprayed on a vertical surface. In this case, the coating would stop flowing in about 1-6 minutes upon UVA exposure after spraying.

The sodium and/or lithium silicate can act as a binder material if they are already in an aqueous solution, or as a filler material if in an encapsulated form as will be subsequently described. Alternatively, the sodium and/or lithium silicate may be in a powder form.

The composition of a first example embodiment of the fire protection and insulation composition according to the present disclosure is shown in the table below titled [Example 1]. A composition according to [example 1] can provide a coating that would transform into a thermal overrun insulation layer at a trigger temperature of, for example, 120° C.

[Example 1]

| Material | Content (wt %) |
|---|---|
| Sodium silicate (SiO₂:Na₂O = 3.22) | 90-95 |
| Corn starch | 1-5 |
| Cellulose | 1-5 |
| Surfactant | 1-5 |

The composition of a second example embodiment of the fire protection and insulative composition according to the present disclosure is shown in the table below titled [Example 2]. A composition according to [example 2] can provide a high thermal conductivity coating that would transform into a thermal overrun insulation at a trigger temperature of, for example, 120° C. while having better water resistance.

[Example 2]

| Material | Content (wt %) |
|---|---|
| Sodium silicate (SiO₂:Na₂O = 3.22) | 30-50 |
| Lithium silicate (SiO₂:Li₂O = 10.00) | 5-20 |
| Aluminum nitride | 30-50 |
| Corn starch | 1-5 |
| Fumed silica | 1-5 |
| Surfactant | 1-5 |

The composition of a third example embodiment of the fire protection and insulative composition according to the present disclosure is shown in the table below titled [Example 3]. A composition according to [example 3] can provide a UV curable high thermal conductivity coating that would transform into insulation at a trigger temperature of, for example, 120° C.

[Example 3]

| Material | Content (wt %) |
|---|---|
| Sodium silicate (SiO₂:Na₂O = 3.22) | 50-65 |
| Boron nitride | 30-50 |
| Irgacure 819 | 1-5 |
| Cellulose | 1-5 |
| Surfactant | 1-5 |

The composition of a fourth example embodiment of the fire protection and insulative composition according to the present disclosure is shown in the table below titled [Example 4]. A composition according to [example 4] can provide a high thermal conductivity paste that would transform into insulation at a trigger temperature of, for example, 120° C.

[Example 4]

| Material | Content (wt %) |
|---|---|
| Sodium silicate (SiO₂:Na₂O = 3.22) | 50-60 |
| Boron nitride | 30-50 |
| Fumed silica | 1-5 |
| Cellulose | 1-5 |
| Surfactant | 1-5 |

The composition of a fifth example embodiment of the fire protection and insulative composition according to the present disclosure is shown in the table below titled [Example 5]. A composition according to [example 5] can provide a high thermal conductivity putty that would transform into insulation at a trigger temperature of, for example, 120° C.

[Example 5]

| Material | Content (wt %) |
|---|---|
| Sodium silicate (SiO₂:Na₂O = 3.22) | 40-60 |
| Boron nitride | 30-50 |
| Gypsum | 3-15 |

All components described in [Examples 1-5] can be processed by mixing at room temperature by using a standard propeller mixer set at 1200 rpm. Mixing time varies between 20-40 minutes and the resulting solution should be fully dispersed without agglomeration. In some cases, phase separation between the solid and liquid components may occur. However, these can be easily dispersed by stirring at 1200 rpm.

According to another aspect of the present invention, the fire protection and insulation composition, may use sodium/lithium silicate in the form of sodium (SMS) or lithium metasilicate hydrates (LMS) as its main component. The sodium and/or lithium metasilicate hydrate may for example be in the form of sodium metasilicate pentahydrate, sodium metasilicate nonahydrate, lithium metasilicate, or lithium disilicate.

Sodium and lithium silicate are highly alkaline compounds and may cause reactions or corrosion when they come in direct contact with certain materials such as aluminum, zinc and polycarbonate. In order to prevent such corrosion and reaction, sodium metasilicate hydrates (SMS) or lithium metasilicate hydrates (LMS) can be incorporated as a filler in other neutral binders such as polydimethylsiloxane (silicone rubber), silane-grafted polyurethane, water-based acrylic and siloxane. These metasilicates can be incorporated in their original forms as long as they do not leach out from the binder. In certain instances where its concentration in the binder is high (e.g. >20 wt %), the leaching out of metasilicate is possible. In such instances, the metasilicate particles can be surface treated or encapsulated in order to significantly reduce surface pH and prevent the particles from reacting with its surrounding environments should they leach out from the binder. Surface treatments of metasilicates can be performed by exposing the particles to acid. A thin layer of crosslinked silica gel would eventually form upon such treatment preceded by neutralized porous silicic acid layer. In order to further stabilize the metasilicate particle surface, the particles can be encapsulated by using a sol-gel approach and related materials. The treatment can be performed in a solvent where the metasilicates remain insoluble or show very limited solubility. The same solvent can allow solubility of the acids and used sol-gel precursors.

According to one possible process according to the present disclosure, a predetermined amount of acid (e.g. maleic or hydrochloric acid) is dissolved in the solvent (e.g. ethanol, methanol, isopropanol). Subsequently, a predetermined amount of metasilicate is added and such formed slurry is left stirred until the acid in the solvent is exhausted (final pH ˜7). In the next step, sol-gel precursors are added. The choice of precursor may include trimethoxymethylsilane (MTMS), triethoxyethylsilane (ETES) and tetraethylorthosilicate (TEOS). The molar ratio of the trifunctional silanes and TEOS may widely vary between 1:10 and 10:1. The mixture is left stirred for at least 60 mins. Such encapsulated metasilicate are washed with excess of the solvent earlier used, separated using vacuum assisted filtration and dried in an vacuum oven at temperatures not exceeding 70° C.

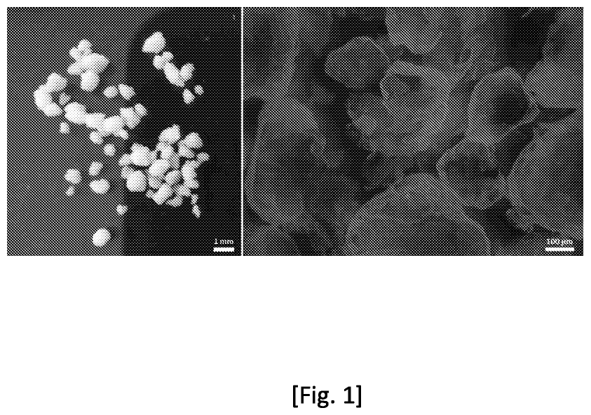

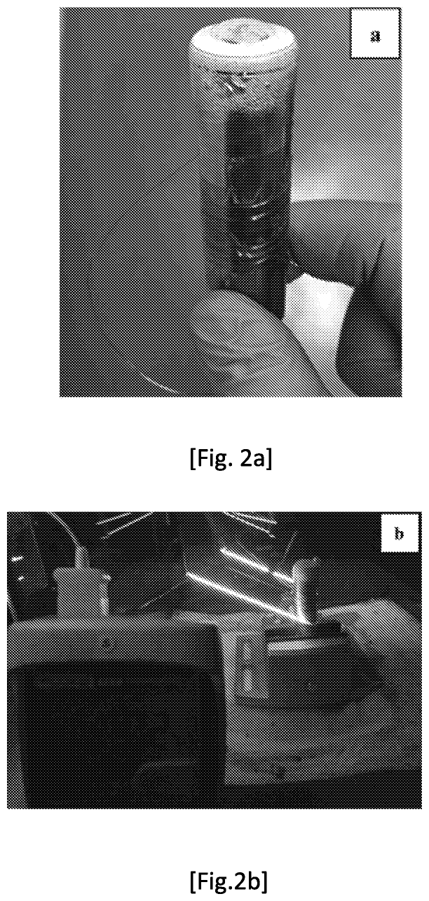

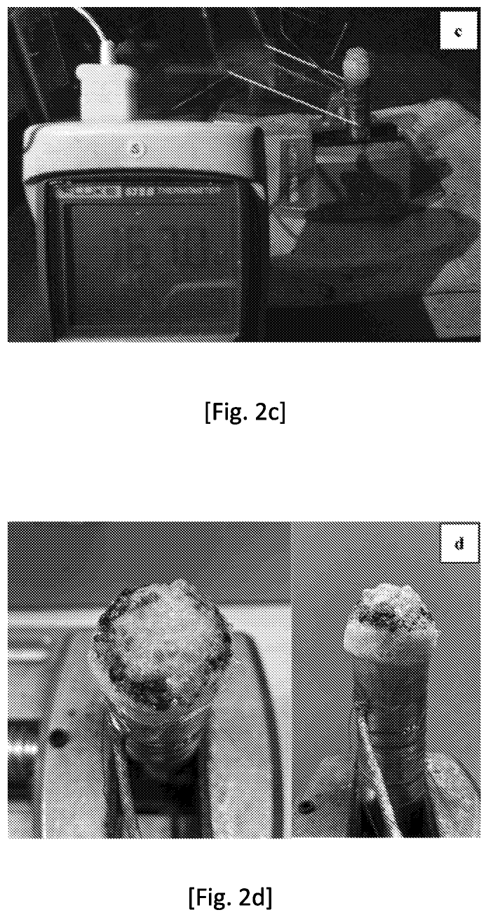

Referring to [FIG. 1], the left image shows the encapsulated metasilicate particles, while the right image shows an optical microphotography of sol-gel formed shells after the metasilicate core was extracted with water.

The composition of a sixth example embodiment of the fire protection and insulative composition according to the present disclosure is shown in the table below titled [Example 6]. A composition according to [example 6] can provide a highly thermally conductive silicone rubber that would transform into insulation at a trigger temperature of, for example, 120° C.

[Example 6]

| Material | Content (wt %) |
|---|---|
| Silicone rubber RTV | 30-70 |
| Boron nitride | 30-70 |
| Acid treated sodium metasilicate pentahydrate | 10-30 |

The composition of a seventh example embodiment of the fire protection and insulation composition according to the present disclosure is shown in the table below titled [Example 7]. A composition according to [example 7] can provide a highly thermally conductive silicone rubber that would transform into insulation at a trigger temperature of, for example, 120° C.

[Example 7]

| Material | Content (wt %) |
|---|---|
| Silicone rubber RTV | 30-70 |
| Boron nitride | 30-70 |
| Alcohol treated lithium metasilicate | 10-30 |

The composition of an eighth example embodiment of the fire protection and insulative composition according to the present disclosure is shown in the table below titled [Example 8]. A composition according to [example 8] can provide a highly thermally conductive silicone rubber that would transform into insulation at a trigger temperature of, for example, 120° C.

[Example 8]

| Material | Content (wt %) |
|---|---|
| Silicone rubber RTV | 30-70 |
| Aluminum nitride | 30-70 |
| Encapsulated sodium metasilicate pentahydrate | 10-30 |

It is also envisaged that reinforcement material be included within the fire protection and insulation composition according to the present disclosure. For example, 5-30 wt % of short inorganic reinforcements such as glass/ceramic wool, chopped-strands, fibers or whiskers can for example be incorporated into the composition to provide additional structural properties if needed. Alternatively, the fire protection and insulation composition according to the present disclosure can also be coated onto continuous inorganic reinforcement material, for example in the form of glass/ceramic mats or fabrics to obtain composite sheets that may contain greater than 50 wt % of such reinforcement material.

Thermal runaway in batteries is mainly caused by overheating, which occurs when the battery is either overcharged or there is an electrical short circuit. When the temperature reaches a point when the separator in the battery collapses, an internal short circuit between the cathode and anode takes place while the highly flammable electrolyte would evaporate and vent through the openings of the battery cell. This would initiate a spontaneous combustion should there be a spark. Once the separator has completely degraded and vented, a redox reaction between the anode and cathode would occur since the electrolyte would allow mass flow of electrons. This reaction triggers the main event of a thermal runaway as it contributes the most heat, which causes significant swelling, rupture, venting, sparking, smoke, fire and explosion. The fire is caused by combustion of gases vented out from the battery chamber when they come into contact with sparks generated by the electrodes. The temperature at which gases are vented from the battery casing depends on the type of solvent used, i.e. DMC (900° C.), EMC (108° C.), and DEC (128° C.). It is noteworthy that combustion will not occur inside the battery cell as there is insufficient amount of oxygen.

Tests were conducted by the Applicant on a hard-case 18650 battery cell by heating that battery cell above 160° C. It was found that thermal runaway of the battery cell would occur within 4 minutes when it is heated above 160° C. Furthermore, profuse venting of the components from the cell was observed after extended heating of the battery cell above 160° C., followed by spewing of sparks from the meltdown of the electrodes, and finally explosion of the battery cell.

When the battery cell was coated at the cathode terminal where the battery vent valve is located with one of the coatings having a composition presented in [examples 1-5], it was found that the thermal runaway did not initiate even when the cell was heated to above 160° C. for more than 90 minutes. The coating thickness at the cathode region was about 0.5-2 mm, as shown in [FIG. 2a]. [FIG. 2b] shows the coated battery being heated to above 160° C. where the coating started to form foam-like structures via hydrothermal crystallization at the top of the battery cell, as shown in [FIG. 2c]. The foaming indicates that the coating was able to absorb heat and form a barrier around the cathode. After the battery was heated for about 90 minutes, brown stains were observed at the coating-cathode interface ([FIG. 2d]) due to the venting of the electrolyte while there was no evidence of sparks, initiation of sparks or combustion. The Applicant elucidates that when the components inside the cell were heated to reach their respective degradation/boiling points, the coating was able to form a porous barrier to release these components but prevent any formation of sparks. The effective prevention of sparks is thought to be the main factor that prevented any spontaneous significant redox reaction between the electrodes and therefore mitigating a full thermal runaway incident.

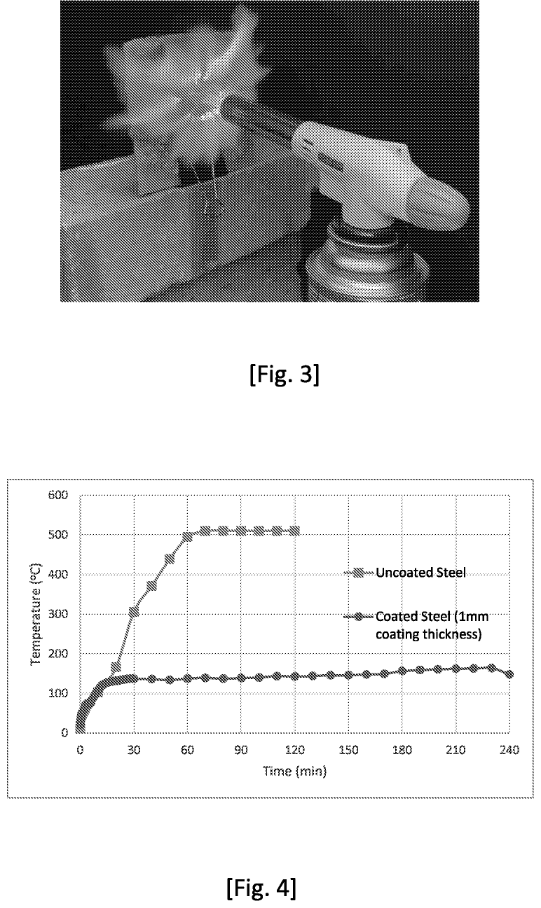

These coatings can also be coated onto metals or plastics such as battery casings and thermal runaway barriers to provide good insulation and fire resistance. It is noteworthy that these coatings exhibit high thermal conductivity (>1 W/m·K) but low electrical conductivity (resistivity>10⁶Ω).

[FIG. 3] shows a fire test conducted on a steel substrate coated with a fire protection and insulation coating according to [example 1-5] of the present disclosure. [FIG. 4] is a graph comparing the substrate temperatures between coated and uncoated steel substrates during fire test shown in [FIG. 3] having coating compositions as described in [Examples 1-5].

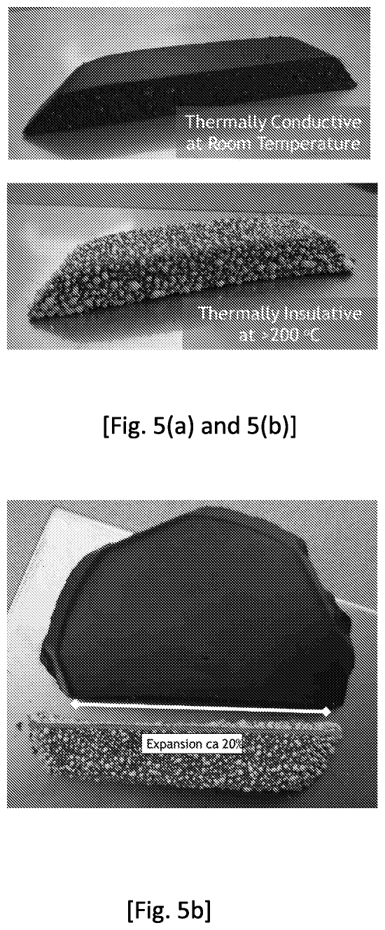

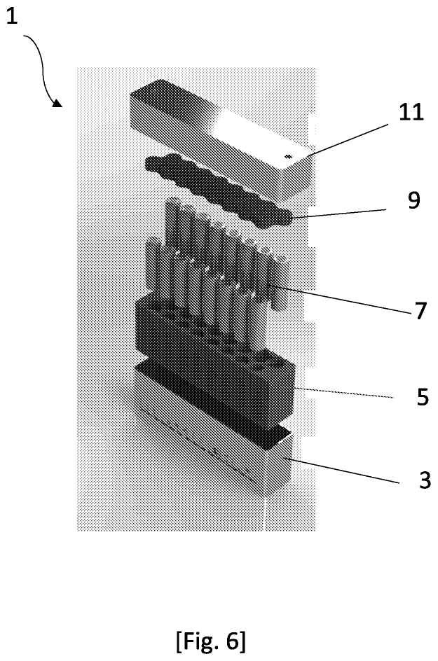

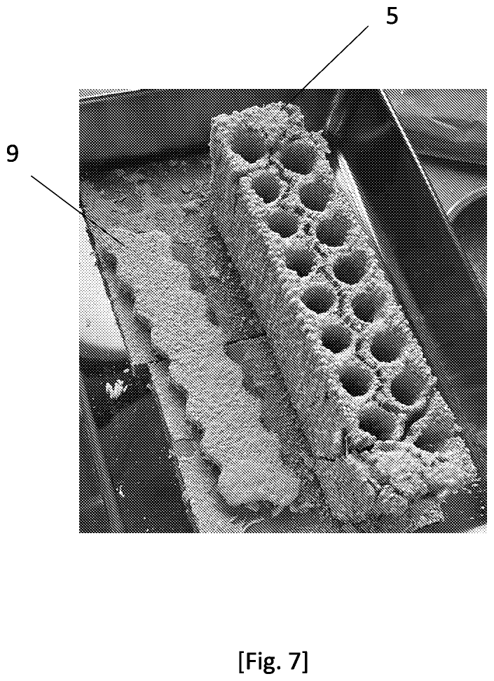

When solid metasilicates in their original or encapsulated form are incorporated into neutral binders such as (but not limited to) polydimethylsiloxanes (PDMS), as listed in [examples 6-8], the resulting compounds would exhibit at least 10 times increase in thermal conductivity as compared to neat PDMS. However, when these compounds are exposed to temperatures above 500° C., foaming would occur and the compounds would exhibit at least 30% better thermal insulation and 20% expansion in volume as compared to neat PDMS. Therefore, these compounds are ideal to be used as a thermal interface material in battery modules to dissipate heat as well as a thermal runaway barrier to prevent the spread of fire in the event of a thermal runaway. The expansion of the compound upon heating would enable the sealing of any gaps present and prevent further propagation of fire.

[FIG. 5(a)] shows the appearance of highly thermally conductive PDMS compound before exposure to high temperature. [FIG. 5(b)] shows the PDMS compound foaming upon exposure to high temperatures (e.g. 200° C.). [FIG. 5(c)] shows how the foaming would also cause expansion to the PDMS compound, for example around 20% in the shown example.

[FIG. 6] shows an example of a battery module 1 comprising a battery casing 3 having a battery casing cover 11. Positioned within the battery casing 3 is a plurality of batteries (e.g., 18650 batteries) with each battery 7 respectively supported within a battery holder 5 fabricated from the highly thermally conductive compounds. Positioned over the batteries 7 is a top protection sheet 9 having a composition according to [example 6-8] of the present disclosure.

[FIG. 7] shows the battery holder 5 and top protection sheet 9 of the battery module 1 of [FIG. 6] when composed of the fire protection and insulation composition according to the present disclosure, and after exposure to temperatures over 120° C. [FIG. 7] in particular shows the hydrothermal crystallization that occurs within the composition of the battery holder 5 and top protection sheet 9 following the exposure to high temperatures.

The fire protection and insulation composition according to the present disclosure may provide the following features and advantages:
i) A halogen-free, water-based coating that could function as both a thermal interface material as well as a thermal runaway barrier in battery modules.
ii) A compound consisting of a pH neutral binder (e.g. PDMS), sodium/lithium metasilicate powder, and ceramic fillers (e.g. boron nitride) that is highly thermally conductive at normal operation temperatures (e.g. between 20-80° C.), which will foam at higher temperatures (e.g. above 120° C.) and transform into a fire-resistant thermal insulation barrier.
iii) An encapsulation method that would provide a pH neutral shell enveloping sodium/lithium metasilicate particles.
iv) An encapsulation method to tune the thickness of the shell such that the trigger temperature (temperature at which the metasilicates starts foaming) can be tuned.
v) A method to coat the battery cell at the cathode terminals where the vents are located in order to prevent the initiation of thermal runaway.
vi) A method to coat the entire battery module with the highly thermally conductive coating that would enable heat dissipation from the battery cells to the battery casing during normal battery working temperatures. The same coating would also transform into a thermal insulation barrier to prevent fire propagation in the event of a thermal runaway.

While the fire protection and insulation coating has been specifically described with reference to its use preventing thermal runaway in batteries, the coasting can also be used in other applications as follows:
i) Coating on a battery to dissipate heat during operational temperatures and to prevent thermal runaway when the battery temperature is too high. Coating can also insulate battery against external heat/flames.
ii) Coating on fire-rated door panels as well as other flammable materials (e.g. wood, polymeric foams, honeycomb cores) to provide additional insulation.
iii) As a flame retardant coating on furniture or panels that are made from combustible materials (e.g. polyurethane foam, wood, plastics, and fabric)
iv) As a fire-protection coating in electrical panels/PCB
v) As a fire-protection and insulation coating in construction materials

Unless defined otherwise, all technical and scientific terms used herein have the same meaning as is commonly understood by a skilled person to which the subject matter herein belongs.

It should be appreciated by the person skilled in the art that the above invention is not limited to the embodiment described, and that modifications and improvements may be made without departing from the scope of the present invention.

It should be further appreciated by the person skilled in the art that one or more of the above modifications or improvements, not being mutually exclusive, may be further combined to form yet further embodiments of the present invention.

1. A fire protection and insulation composition comprising:
sodium and/or lithium silicate, and an additional or other filler or binder material, wherein the composition, when applied to a said battery cell, acts as a thermally conductive coating at normal working temperatures of the battery cell, and wherein the sodium and/or lithium silicate undergoes hydrothermal crystallization into amorphous silica when exposed to higher temperatures such that the coating acts as a thermally insulative barrier for the battery cell.

2. A fire protection and insulation composition according to claim 1, wherein the filler material comprises one or more of a pore-forming agent, rheology modifier, thermal insulation filler, and thermal conductive filler.

3. A fire protection and insulation composition according to claim 2, wherein the pore-forming agent is a starch.

4. A fire protection and insulation composition according to claim 2 or 3, wherein the pore-forming agent is provided by the sodium and/or lithium silicate.

5. A fire protection and insulation composition according to any one of claims 2 to 4, wherein the rheology modifier is a starch, fumed silica and/or cellulose or cellulose derivatives.

6. A fire protection and insulation composition according to claim 3 or 5, wherein the starch is derived from corn, tapioca, wheat or rice.

7. A fire protection and insulation composition according to any one of claims 2 to 6, wherein the thermal insulation filler is fumed silica and/or aerogel.

8. A fire protection and insulation composition according to any one of claims 2 to 7, wherein the thermal conductive filler is selected from one or more of the following: boron nitride, aluminium nitride, aluminium oxide and magnesium oxide.

9. A fire protection and insulation composition according to any one of the preceding claims, further comprising a UV curing agent.

10. A fire protection and insulation composition according to any one of the preceding claims, further comprising cellulose.

11. A fire protection and insulation composition according to any one of the preceding claims, further comprising a surfactant.

12. A fire protection and insulation composition according to any one of the preceding claims, further comprising gypsum.

13. A fire protection and insulation composition according to any one of the preceding claims, wherein the sodium and/or lithium silicate is in the range of 35-60 Baume.

14. A fire protection and insulation composition according to claim 1, wherein the sodium and/or lithium silicate is in the form of a powder.

15. A fire protection and insulation composition according to claim 2, comprising:
a) 90-95 wt % of sodium silicate;
b) 1-5 wt % of corn starch;
c) 1-5 wt % of cellulose; and
d) 1-5% of a surfactant.

16. A fire protection and insulation composition according to claim 2, comprising:
a) 30-50 wt % of sodium silicate;
b) 5-20 wt % of lithium silicate;
c) 30-50 wt % of aluminium nitride;
d) 1-5 wt % of corn starch;
e) 1-5 wt % of fumed silica; and
f) 1-5 wt % of a surfactant.

17. A fire protection and insulation composition according to claim 2, comprising:
a) 50-65 wt % of sodium silicate;
b) 30-50 wt % of boron nitride;
c) 1-5 wt % of irgacure 819;
d) 1-5 wt % of cellulose; and
e) 1-5 wt % of a surfactant.

18. A fire protection and insulation composition according to claim 2, comprising:
a) 50-60 wt % of sodium silicate;
b) 30-59 wt % of boron nitride;
c) 1-5 wt % of fumed silica;
d) 1-5 wt % of cellulose; and
e) 1-5 wt % of surfactant.

19. A fire protection and insulation composition according to claim 2, comprising:
a) 40-60 wt % of sodium silicate (SiO2:Na2O=3.22);
b) 30-50 wt % of boron nitride; and
c) 3-15 wt % gypsum.

20. A fire protection and insulation composition according to claim 1, wherein the sodium and/or lithium silicate is in the form of a sodium and/or lithium metasilicate hydrate.

21. Afire protection and insulation composition according to claim 20, wherein the sodium and/or lithium metasilicate hydrate is in the form of sodium metasilicate pentahydrate, sodium metasilicate nonahydrate, lithium metasilicate, or lithium disilicate.

22. A fire protection and insulation composition according to claim 20 or 21, wherein the sodium and/or lithium metasilicate hydrate is in an encapsulated form.

23. A fire protection and insulation composition according to any one of claims 20 to 22, wherein the binder material is silicone rubber RTV.

24. A fire protection and insulation composition according to any one of claim 20 to 22, wherein the binder material is silane-grafted polyurethane.

25. A fire protection and insulation composition according to any one of claim 20 to 22, wherein the binder material is water-based acrylic.

26. A fire protection and insulation composition according to any one of claim 20 to 22, wherein the binder material is siloxane.

27. A fire protection and insulation composition according to any one of claims 20 to 26, further comprising a thermal conductive filler.

28. A fire protection and insulation composition according to claim 27, wherein the thermal conductive filler is selected from one or more of the following: boron nitride, aluminium nitride, aluminium oxide and magnesium oxide.

29. A fire protection and insulation composition according to claim 23, comprising:
a) 30-70 wt % of silicone rubber RTV;
b) 20-70% of boron nitride; and
c) 10-30 wt % of acid treated sodium metasilicate pentahydrate.

30. A fire protection and insulation composition according to claim 23, comprising:
a) 30-70 wt % of silicone rubber RTV;
b) 30-70 wt % boron nitride;
c) 10-30 wt % acid treated lithium metasilicate; and
d) 10-30 wt % encapsulated sodium metasilicate nonahydrate.

31. A fire protection and insulation composition according to claim 23, comprising:
a) 30-70 wt % of silicone rubber RTV;
b) 30-70 wt % aluminium nitride; and
c) 10-30 wt % encapsulated sodium metasilicate pentahydrate.

32. A fire protection and insulation composition according to claim 24, comprising:
a) 30-70% silane-grafted polyurethane;
b) 20-70% boron nitride;
c) 1-5% siloxane;
d) 1-3% surfactant; and
e) 10-30% sodium metasilicate pentahydrate.

33. A fire protection and insulation composition according to claim 25, comprising:
a) 30-70% water-based acrylic;
b) 20-70% boron nitride;
c) 1-3% surfactant; and
d) 10-30% sodium metasilicate pentahydrate.

34. A fire protection and insulation composition according to claim 23, comprising:
a) 30-70% silicone rubber RTV;
b) 10-50% boron nitride;
c) 20-50% siloxane;
d) 1-3% surfactant; and
e) 10-30% sodium metasilicate pentahydrate.

35. A fire protection and insulation composition according to any one of the preceding claims, further comprising 5 to 30 wt % of reinforcement material.

36. Afire protection and insulation composition according to claim 35, wherein the reinforcement material is selected from one or more of the following: glass/ceramic wool, chopped-strands, fibers or whiskers.

37. A composite sheet comprising an inorganic reinforcement layer, to which is applied a layer of the fire protection and insulation composition according to any one of the preceding claims.

38. A composite sheet according to claim 37, wherein the inorganic layer is in the form of a glass/ceramic mat or a fabric.

39. A method of providing fire protection and insulation for a battery cell, comprising coating or covering at least a cathode and/or a vent of the battery cell with a fire protection and insulation coating as claimed in any one of the preceding claims.
